(19) United States
(12) Patent Application Publication
(10) Pub. No.: US 2025/0030793 A1
(43) Pub. Date: Jan. 23, 2025

(54) MOTIVATIONAL ALARM CLOCK SYSTEM

(71) Applicant: Eric Whitney Jones, Blackfoot, ID (US)

(72) Inventor: Eric Whitney Jones, Blackfoot, ID (US)

(21) Appl. No.: 18/754,346

(22) Filed: Jun. 26, 2024

Related U.S. Application Data
(60) Provisional application No. 63/528,109, filed on Jul. 21, 2023.

(51) Int. Cl. H04M 1/72451; G06F 3/04817; G06F 3/0482; G06Q 30/02

(52) U.S. Cl. CPC H04M 1/72451; G06F 3/04817; G06F 3/0482; G06Q 30/02

(57) ABSTRACT

A motivational alarm clock system may include an application that is downloaded onto a smart device. The application may include programming so as to function and be downloadable on both Android and iPhone devices. When a user accesses a drop-down menu, the user may choose any of the following menus: (1) alarm menu that allows access to alarm features; (2) a category menu that may define the topic the user would like to hear; and (3) a goal menu. The user selects the topic or specific speech that will be played either before or after the alarm sounds. After the alarm ceases, a pre-recorded message, speech, etc. that meets the pre-determined speech criteria selected by the user will be played.

### CROSS-REFERENCE TO RELATED APPLICATIONS

This application claims the benefit of U.S. Provisional Application Ser. No. 63/528,109, filed on Jul. 21, 2023, which is incorporated herein by reference.

### TECHNICAL FIELD

The present disclosure relates to an alarm clock system. More particularly, the present disclosure relates to an alarm clock mobile application that includes and has access to motivational media.

### BACKGROUND

Modern-day life has become more and more busy for individuals. To be able to wake up when needed and accomplish daily tasks, has become increasingly more difficult for numerous individuals. Many rely on clocks and their alarms to arise in the morning. In fact, alarm clocks have been used for thousands of years and were created to help individuals wake up in the morning or at other times to get to, for example, their jobs. Today, almost every person relies on some form of alarm clock to be able to wake up. Without these clocks, individuals may oversleep, being late to fulfill their responsibilities, which may lead to life altering changes, and potentially, health and/or mental conditions. Because of these alarm clocks, the world continues to function properly.

While alarm clocks are useful in waking an individual, they can be frustrating, especially when waking to an unpleasant alarm sound. As such, companies have made alarm sounds that are peaceful and easy to wake to. Alarm clocks on the market were developed to wake an individual only. At times, it is difficult to start a day with just an alarm clock, especially when starting a day off right is extremely important to how the rest of the day will be. Accordingly, alarm clocks used today have a major shortcoming, meaning they perform a single function. That is, to wake up an individual, without any regard to the mental state or well-being of the individual.

Accordingly, there is a need for an alarm clock that allows individuals to take advantage of their mornings, accomplish more, live a more fulfilling life, and ultimately, start each day off right. The present invention seeks to solve these and other problems.

### SUMMARY OF EXAMPLE EMBODIMENTS

In one embodiment, a motivational alarm clock system may comprise an application that is downloaded onto a smart device. The smart device may comprise a display, a processor, and memory. The application may utilize storage on the smart device and/or storage on a cloud platform to store motivational speeches. The smart device via the application may communicate with the cloud platform, which in turn, communicates with the smart device. The cloud platform may store motivational speeches thereon.

In one embodiment, an alarm clock system may include programming so as to function and be downloadable on both Android® and iPhone® devices. A user may access the main user interface, which may comprise a drop-down menu that when accessed may allow the user to configure a number of settings to establish an optimal user experience. When the user accesses the drop/pull down menu, the user may choose any of the following menus (text-based or icon-based): (1) the user may access a category menu that may define the topic the user would like to hear, (2) an alarm menu that allows access to alarm features, and (3) a goals menu that allows a user to enter his or her goal(s).

In one embodiment, a media library on the mobile application may be accessed by content artists, where they can upload content. Content may be pulled randomly from the cloud platform after meeting, for example, two criteria: first, the content must fall within the domain of the topics selected by the user; and second, content will not be repeated until all other content within the filtered topics have been exhausted.

### BRIEF DESCRIPTION OF THE DRAWINGS

FIG. 1 illustrates a smart device of a motivational alarm clock system;

FIG. 2 illustrates a diagram of a motivational alarm clock system;

FIG. 3 illustrates a flowchart of a motivational alarm clock system; and

FIG. 4 illustrates a flowchart of a motivational alarm clock system.

### DETAILED DESCRIPTION OF EXAMPLE EMBODIMENTS

While embodiments of the present disclosure may be subject to various modifications and alternative forms, specific embodiments have been shown by way of example in the drawings and will be described in detail herein. However, the present disclosure is not intended to be limited to the particular features, forms, components, etc. disclosed. Rather, the present disclosure will cover all modifications, equivalents, and alternatives falling within the scope of the present disclosure.

Reference to the invention, the present disclosure, or the like are not intended to restrict or limit the invention, the present disclosure, or the like to exact features or steps of any one or more of the exemplary embodiments disclosed herein. References to “one embodiment,” “an embodiment,” “alternate embodiments,” “some embodiments,” and the like, may indicate that the embodiment(s) so described may include a particular feature, structure, or characteristic, but not every embodiment necessarily includes the particular feature, structure, or characteristic.

Any arrangements herein are meant to be illustrative and do not limit the invention's scope. Although specific terms are employed herein, they are used in a generic and descriptive sense only and not for purposes of limitation. Unless otherwise defined herein, such terms are intended to be given their ordinary meaning not inconsistent with that applicable in the relevant industry and without restriction to any specific embodiment hereinafter described.

It will be understood that the steps of any such processes or methods are not limited to being carried out in any particular sequence, arrangement, or with any particular graphics or interface. In fact, the steps of the disclosed processes or methods generally may be carried out in various, different sequences and arrangements while still being in the scope of the present invention. Certain terms are used herein, such as “comprising” and “including,” and similar terms are meant to be “open” and not “closed” terms. These terms should be understood as, for example, “including, but not limited to.”

Portions of the motivation alarm clock may be implemented wholly in hardware, wholly in software or combining software and hardware implementation that may all generally be referred to herein as a “circuit,” “module,” “component,” or “system.” It will be understood that computer program code for carrying out operations for features of the motivation alarm clock on a smart/computing device may be written in any programming language, which may include, but is not limited to, Objective-C, C++, C #, VB.NET, Java, Python, “C” programming language, Visual Basic, Perl, COBOL 2002, PHP, ABAP, Python, PHP, HTML, AJAX, or Ruby and Groovy. The program code may operate any portion of the system.

Portions of the motivation alarm clock are illustrated in flowcharts and/or block diagrams. These flowcharts and/or block diagrams depict computer and mobile application program products according to embodiments of the system described herein. It will be understood that each block of the flowchart illustrations and/or block diagrams, and combinations of blocks in the flowchart illustrations and/or block diagrams, can be implemented by computer or mobile application program instructions.

As previously described, there is a need for an alarm clock that allows individuals to take advantage of their mornings, accomplish more, live a more fulfilling life, and ultimately, start each day off right. The present invention seeks to solve these and other problems.

With the busyness of life, many individuals rely on alarm clocks to wake up early and accomplish their tasks and goals. If alarm clocks are not used, there may be a lot of people that sleep longer than necessary, which could cause issues with their employment, or in some situations, health issues. Accordingly, alarm clocks are truly an important component of modern-day life.

Even though alarm clocks are necessary, individuals often dislike alarm clocks and the sounds that they produce to wake up someone. Some of the sounds produced by alarm clock are agitating, leading to an individual waking up in an unpleasant mood. Being productive or unproductive during the day, often is a product of how someone wakes up. Some companies have changed alarm clock sounds; however, just waking up can lead to starting the day off on the wrong foot. Ultimately, alarm clocks do nothing to provide motivation for an individual.

The motivational alarm clock system described herein comprises a smart device with a mobile application. The mobile application may interact with storage on the smart device and a cloud platform, where media may be stored. The motivational alarm clock system may allow content creators, those who give motivational speeches or provide similar content, to upload their content to the mobile application or to a website that is connected to the mobile application. The motivational alarm clock system may be configured to play an initial short sound or song to prompt a user to awaken. The initial sound may be followed by a message (e.g., an inspiring, motivational message) to start a user's day. The message may include, but is not limited to, the following topics: physical fitness/weight loss, mental awareness/meditation, addiction recovery, financial health, parenting strategies, topics for youth, and any other topic. The mobile application may be configured with the option to filter different genres of messages, track goals and progress, and send personalized messages to family members or others. Any users of the mobile application who desire to participate in providing content will be offered advertising through the mobile application.

It will be appreciated that the motivational alarm clock mobile application may help people to have the motivation to wake up at a desired hour in the right mindset to begin a productive day and help people focus on the things that matter most. It will further be appreciated that the motivational alarm clock is simple and convenient to use, allowing a user to easily listen to any topic from his or her smart device.

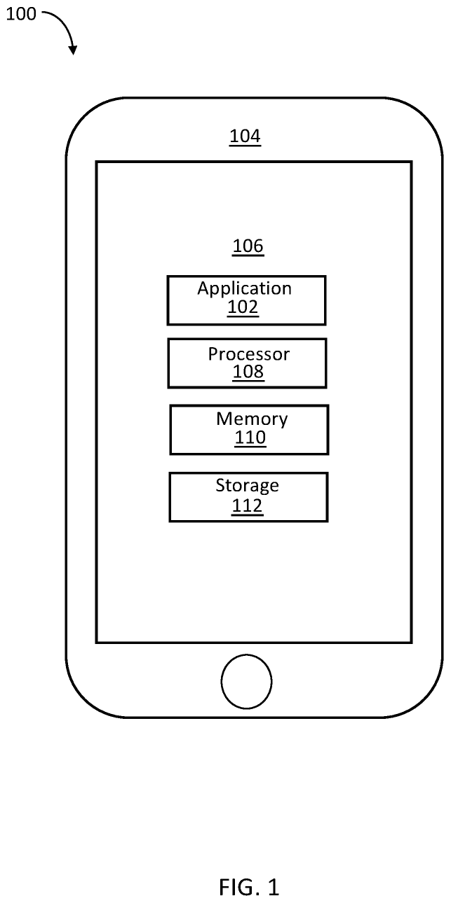

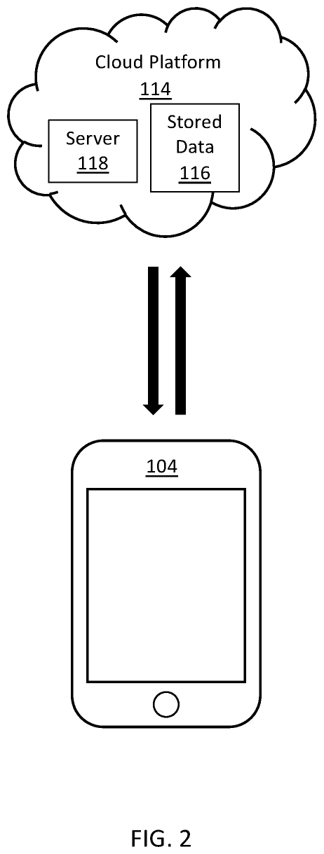

As shown in FIG. 1-2, in one embodiment, a motivational alarm clock system 100 (hereinafter referred to herein as the “alarm clock”) may comprise a mobile application 102 that is downloaded onto a smart device 104. The smart device 104 may comprise a tablet, smart phone, desktop computer, laptop computer, etc. The smart device 104 may comprise a display 106 (e.g., a touch screen display), a processor 108, and memory 110. The memory 110 may be RAM, such as LPDDR, LPDDR2, LPDDR3, LPDDR4, or any other variation of RAM. The memory 110 may also comprise ROM, such as EPROM or Flash EEPROM. The application 102 may utilize storage 112 on the smart device 104 and/or storage on a cloud platform 114 to store a) sounds and songs, and b) messages (e.g., motivational speeches).

The smart device 104 via the application 102 may communicate with the cloud platform 114, which in turn, communicates with the smart device 104. The smart device 104 and cloud platform 114 may each comprise stored data 116 and other features necessary to operate the application 102. For example, the cloud platform 114 may store the sounds, songs, and messages on a server on the cloud (i.e., a cloud server) or at a physical location that is accessed via the cloud platform 114. The server 118 may comprise the stored data 116, which may interact with the application 102 on the smart device 104. In other embodiments, the server 118 on the cloud platform 114 may comprise artificial intelligence (AI) technology that operates to update speeches and pull speeches from public domain websites or other locations, where licenses have been granted.

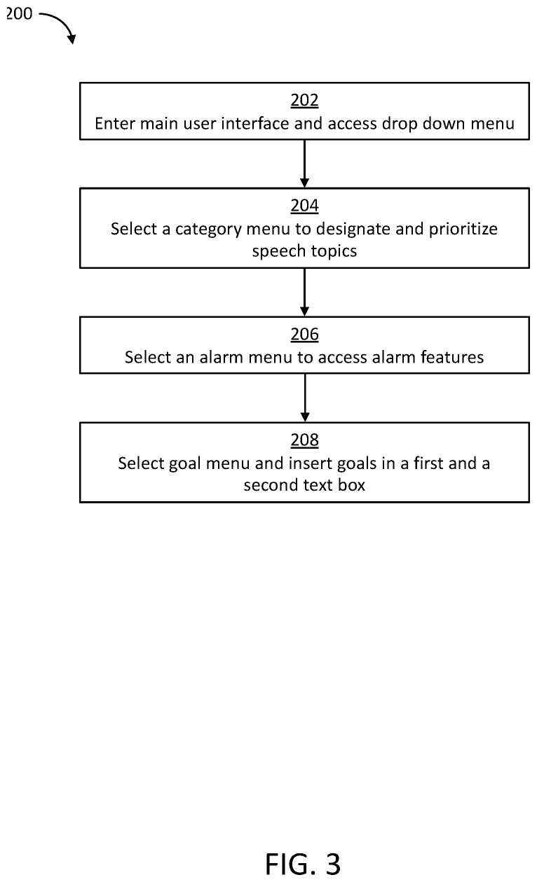

As shown in FIG. 3, in one embodiment, an alarm clock system 200 may include programming so as to function and be downloadable on both Android® and iPhone® devices. A user may download the application and, in some embodiments, on a main user interface, a banner (e.g., 7-day free trial) may auto-populate that if the user selects the banner by pressing thereon, then the free trial may begin. At step 202, the user may access the application and access the main user interface, which may, in some embodiments, comprise a settings icon that when accessed may allow the user to configure a number of settings to establish an optimal user experience. Particularly, when the user accesses a drop/pull down menu, the user may choose any of the following menus (text-based or icon-based): (1) the user may access a category menu that may define the topic the user would like to hear, such as the speakers the user would like to hear from, the speed at which the message plays, or other categories that may be helpful. At step 204, the user selects the topic or specific speech that will be played either before or after the alarm. The user may select different types of messages or speeches that are available in a media library found on the mobile application. The media library of the mobile application may interact with the stored data 116 on the phone, the cloud platform 114, and/or a website. The media library may include numerous types of messages and speeches of varying lengths so as to allow users the ability to select and customize their listening media. The speeches and other information the user may listen to may include topics such as weight loss, financial management, business growth, personal development, fitness, and more; (2) alarm menu that allows access to alarm features (e.g., time of alarm, repetition of the alarm, length of the alarm (i.e., alarm adjustments), and type of alarm whether a sound or song), at step 206; and (3) a goals menu that allows a user to enter his or her goal in a first text box with a few words and then a second text box where the user may describe the goal in detail at step 208. It should be noted that these menus may also be accessed via icons on the main user interface.

After the user has selected an alarm, the alarm sounds at the selected time. The alarm may include an alarm song or alarm sound (e.g., brief sound, for example, a buzzer, musical chime, or other sound that plays from speakers on the smart device to wake the user). Instead of the alarm, the user may also select a pre-recorded speech to begin prior to the time set for the alarm, for example, five minutes before a scheduled alarm. That way, the user can spend time preparing for the day by listening to the motivational dialog, without waking up to an alarm. The alarm may sound for a pre-determined amount of time, which is set by the user. After the alarm ceases, a pre-recorded message, speech, etc. that meets the pre-determined speech criteria selected by the user will then play. The speeches may play for a pre-selected amount of time or until finished. In some embodiments, the speeches may play for a period of time between 4-6 minutes. It will be appreciated that the user may be able to remain in bed while listening to the pre-selected message or choose to begin the day. Because of this application, users may have increased drive and motivation, helping them accomplish more in a day and have a better outlook on life. Audiences may vary from young to old and may look to the application to live a more productive and purpose-filled lifestyle.

The application may help users who have a difficult time getting out of bed and starting their days. In some embodiments, the application may be used for single consumers or for large corporations offered as a corporate plan for employees. The application may be subscription-based, where the user may purchase a subscription that lasts for a period of time, such as a year. The subscription allows access to the application for the period of time that was paid for by the user. The application is accessed once the subscription payment is made. The payment may be made manually before access and after each subscription ends or may be made through automatic payments.

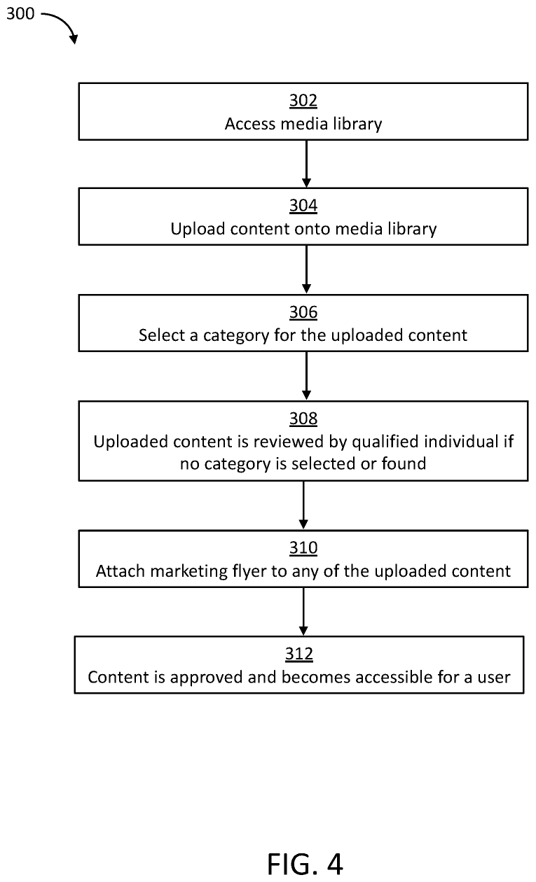

FIG. 4 illustrates a diagram that details the steps to upload content to the media library for a motivational alarm clock system 300. The media library for the mobile application may be accessed by content artists (i.e., motivational speakers) and/or companies owning rights to speeches at step 302. Specifically, at step 304, content artists may have access to a website (i.e., content platform) or mobile application 102 where they may be able to upload their content, which may be accessed by users on the media library. At step 306, the content artist may select a category on the website that describes the content being uploaded. If none of the categories fit the type of content, then, in some embodiments, a qualified individual may review, contact, and discuss the submission with the content artist so as to place the content in the appropriate category at step 308. In other embodiments, if the content artist cannot find the proper category, then the content artist may select a miscellaneous category during the submission process. In other embodiments, individuals may review the miscellaneous submissions to see if there is an applicable defined category; however, if there is not a category, the submission may remain in the miscellaneous category. At step 310, the user may add a marketing flyer to any of the uploaded content so as to offer advertising for each uploaded media file. At step 312, prior to being posted on the media library, all content submissions go through an approval process before becoming accessible to users/consumers. In addition, content is pulled randomly from the cloud platform after meeting, for example, two criteria: first, the content must fall within the domain of the topics selected by the user; and second, content will not be repeated until all other content within the filtered topics have been exhausted. If the user would like to hear content repeatedly, the user may place that content into a favorites folder that will communicate with the application to play that content more often. While content may be stored on the cloud platform and streamed therefrom, consumers may have an option to download some content so as to be able to listen in geographical locations where access to internet and the cloud is limited. In addition, the application 102 may interact with podcast platforms, where a user may pull various podcasts into the media library on the application or may have access to the platforms to download or stream therefrom, so that users may wake up to their favorite podcasts.

Further, and as discussed above in step 310, the content artists may be able to upload a promotional coupon/marketing flyer or bio on the website along with their content. The promotional coupon may be displayed on a pop-up on the main user interface of the application when the content is presented to the user. If the user clicks on the pop-up, the user may learn more about the speaker and the speaker's programs. It will be appreciated that because of the pop-up, content artist may be more motivated to either submit content for the first time or submit additional content. Content artists may submit content for free and gain traction for their own content from free marketing on the application. Pricing may be set monthly or annually and may vary between consumer and corporations. For example, an individual may pay $1.99 a month while a corporation may pay 0.99 cents a month per employer.

The application 102 may further include a record function that would allow a user to record a message that could be uploaded to the media library, upon approval by the user and verification that the recorded message meets required standards. As such, any user would be capable of accessing any other user's uploaded, recorded message and listen to it. These recordings may include messages such as a mother recording a message for her son who lives away from home, emergency response teams recording a message for immediate dissemination to a team who need to report early for an emergency, and an individual recording personal affirmations for personal growth.

While the motivational speaker alarm clock is discussed being used with a mobile application, in some embodiments, the alarm clock may be a physical apparatus that either stores the content or interacts with the cloud platform wirelessly (e.g., Bluetooth®) or with a wire.

It will be understood that while various embodiments have been disclosed herein, other embodiments are contemplated. Further, certain embodiments of the present disclosure may include, incorporate, or otherwise comprise properties or features described in other embodiments. Consequently, various features of certain embodiments can be compatible with, combined with, included in, and/or incorporated into other embodiments of the present disclosure. Therefore, disclosure of certain features or components relative to a specific embodiment of the present disclosure should not be construed as limiting the application or inclusion of said features or components to the specific embodiment unless stated. As such, other embodiments can also include said features, components, members, elements, parts, and/or portions without necessarily departing from the scope of the present disclosure. The embodiments described herein are examples of the present disclosure. Although only a few of the example embodiments have been described in detail herein, those skilled in the art will appreciate that modifications are possible without materially departing from the present disclosure described herein. Accordingly, all modifications may be included within the scope of this invention.

What is claimed is:

1. A motivational alarm clock system comprising:
a smart device;
a mobile application on the smart device, the mobile application comprising:
a main user interface that allows access to one or more motivational topics; and
a content platform where content is uploaded, the content platform comprising
upload features and selectable digital marketing flyers that are attachable to each uploaded content.

2. The motivational alarm clock system of claim 1, wherein the smart device is a tablet, smart phone, desktop computer, or laptop computer.

3. The motivational alarm clock system of claim 1, wherein the main user interface comprises a drop-down menu.

4. The motivational alarm clock system of claim 3, wherein the drop-down menu comprises a category menu, an alarm menu, and a goals menu.

5. The motivational alarm clock system of claim 4, wherein the category menu comprises a list of motivational topics and speakers that can be selected based on inputted goals.

6. The motivational alarm clock system of claim 4, wherein the alarm menu comprises one or more alarm features.

7. The motivational alarm clock system of claim 6, wherein the one or more alarm features consist of at least one selected from the group consisting of:
an alarm sound,
an alarm song, and
alarm adjustments.

8. The motivational alarm clock system of claim 4, wherein the goals menu comprises a first text box and a second text box, wherein the first text box is capable of receiving less words than the second text box.

9. The motivational alarm clock system of claim 1, wherein the main user interface comprises a category menu icon, an alarm menu icon, and a goals menus icon.

10. The motivational alarm clock system of claim 1, wherein the content platform comprises a website.

11. A method of utilizing a motivational alarm clock system comprising:
accessing a mobile application with a main user interface on a smart device;
accessing a drop-down menu or icons from the main user interface;
opening a category menu from the drop-down menu or icons to select a motivational topic or speaker;
opening an alarm menu from the drop-down menu or icons to set alarm features;
opening a goals menu from the drop-down menu or icons to insert goals that are in line with the motivational topic.

12. The method of claim 11, wherein the alarm menu allows access to setting time for an alarm, repetition of the alarm, and length of the alarm.

13. The method of claim 11, wherein the motivational topic comprises a speech, message, or song.

14. The method of claim 11, further comprising selecting, from the category menu, the length of the motivational message, language, and topic.

15. The method of claim 11, wherein the category menu comprises a list of motivational topics and speakers that can be selected based on inputted goals.

16. The method of claim 11, wherein the alarm menu comprises one or more alarm features.

17. The method of claim 11, wherein the goals menu comprises a first text box and a second text box that receive goals, wherein the first text box is capable of receiving less words than the second text box.

18. A method of uploading content to and utilizing a motivational alarm clock system, the method comprising:
uploading content to a content platform that interacts with a mobile application on a smart device by:
selecting a category that describes the content to be uploaded;
attaching the content file and uploading to the media library; and
attaching a marketing flyer to the uploaded content that is advertised to users when accessing the content;
accessing a mobile application with a main user interface on a smart device;
accessing a drop-down menu or icons from the main user interface;
opening a category menu from the drop-down menu or icons to select a motivational topic or speaker or the content;
opening an alarm menu from the drop-down menu or icons to set alarm features;
opening a goals menu from the drop-down menu or icons to insert goals that are in line with the motivational topic.

19. The method of claim 18, wherein the content uploaded to the content platform passes through a review process to ensure proper categorization of the content prior to it being available to a user.
